(19) United States
(12) Patent Application Publication
(10) Pub. No.: US 2010/0321777 A1
(43) Pub. Date: Dec. 23, 2010

(54) METHOD AND APPARATUS FOR OPTIMIZING STEREOSCOPIC EFFECT IN A CAMERA

(75) Inventors: Juan Martinez, Hewitt, NJ (US); Andrew Berger, Pearl River, NY (US)

Correspondence Address: RAYMOND R. MOSER JR., ESQ.;MOSER IP LAW GROUP, 1030 BROAD STREET, SUITE 203, SHREWSBURY, NJ, 07702, US

(73) Assignees: SONY CORPORATION, Tokyo (JP); SONY ELECTRONICS INC., Park Ridge, NJ (US)

(21) Appl. No.: 12/487,443

(22) Filed: Jun. 18, 2009

(51) Int. Cl. G02B 27/26; G02B 27/22

(52) U.S. Cl. 359/465; 359/466

(57) ABSTRACT

A method for optimizing stereoscopic effect in a three-dimensional image is provided. The method for optimizing stereoscopic effect comprises capturing a first unpolarized beam of light representing a first image and a second unpolarized beam of light representing a second image using a lens module, converting the first and second unpolarized beam of light into the first polarized beam of light and the second polarized beam of light using a filter module and adjusting separation and convergence of the lens module using a lens control module for generating an output stream.

### BACKGROUND

1. Field of the invention

Embodiments of the present invention generally relate to three-dimensional imaging techniques and, more particularly, to a method and apparatus for optimizing stereoscopic effect in a camera.

2. Description of the Related Art

Rapid proliferation and progression of three-dimensional digital camera technology has resulted in widespread usage among various users (e.g., amateur users, professional users and/or the like). Such three-dimensional digital cameras produces high definition stereoscopic images and video.

Generally, stereoscopic imaging involves capturing two images of a scene (e.g., an object, a person, a place and/or the like) to simulate the process by which the brain perceives three-dimensional objects. To perceive the depth dimension of the image, the brain utilizes the horizontal displacement of the images provided by both eyes to create parallax (i.e. an apparent displacement of the object when viewed along two different lines of sight). The brain merges the two images captured by both eyes to perceive this parallax as the dimension of depth and thus, allows a person to see the object as a solid object in three spatial dimensions, such as width, height, and depth (i.e. x, y and z coordinates).

Conventionally, there exist various techniques for capturing high definition three-dimensional images. Such techniques primarily utilize two separate cameras and/or lenses for capturing the scene. However, the two separate cameras must be identical to each other (e.g., provided by same vendor). Additionally, the image capturing settings of the two separate cameras must be synchronized, which is difficult to achieve and consumes a significant amount of time. For example, the capturing settings (e.g., a zoom length, an iris, a focal length and/or the like) of the two lenses are difficult to control and synchronize. The use of two cameras decreases reliability and usability while increasing the cost and weight of the imaging assembly.

Therefore, there is a need in the art for a method and apparatus for optimizing stereoscopic effect by controlling lens operations in a camera.

### SUMMARY OF THE INVENTION

Embodiments of the present disclosure generally include a method and apparatus for optimizing stereoscopic effect. In one embodiment, a method for optimizing stereoscopic effect in a camera is provided. The method for optimizing stereoscopic effect comprises capturing a first unpolarized beam of light representing a first image and a second unpolarized beam of light representing a second image using a lens module, converting the first and second unpolarized beam of light into the first polarized beam of light and the second polarized beam of light using a filter module and adjusting separation and convergence of the lens module using a lens control module for generating an output stream.

In another embodiment, an apparatus for optimizing stereoscopic effect is provided. The apparatus includes a lens module for capturing a first unpolarized beam of light representing a first image and a second unpolarized beam of light representing a second image, a filter module for converting the first and second unpolarized beam of light into the first polarized beam of light and the second polarized beam of light; and a lens control module for adjusting separation and convergence of the lens module for generating an output stream.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of an apparatus for optimizing stereoscopic effect, according to one or more embodiments of the present invention;

FIG. 2 is a block diagram of a lens module, according to one or more embodiments of the present invention;

FIG. 3 is a detailed block diagram of an embodiment of a lens module for capturing polarized light in accordance with an embodiment of the present invention;

FIG. 4 is a detailed block diagram of a lens module, according to one or more embodiments of the present invention; and

FIG. 5 is a flow diagram of a method for optimizing stereoscopic effect, according to one or more embodiments of the present invention.

### DETAILED DESCRIPTION

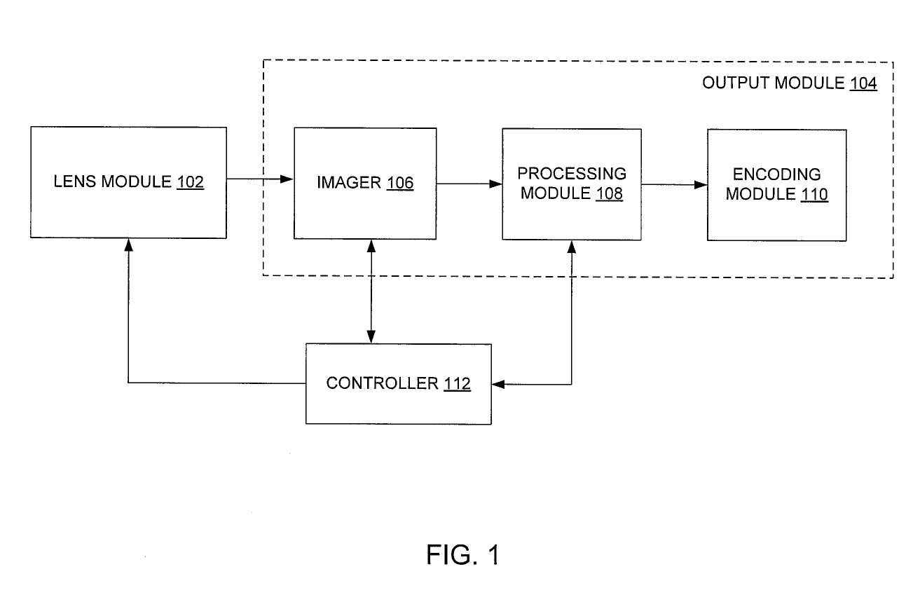

FIG. 1 is a block diagram of an apparatus for optimizing stereoscopic effect according to one or more embodiments of the present invention. The apparatus includes a lens module 102, and an output module 104.

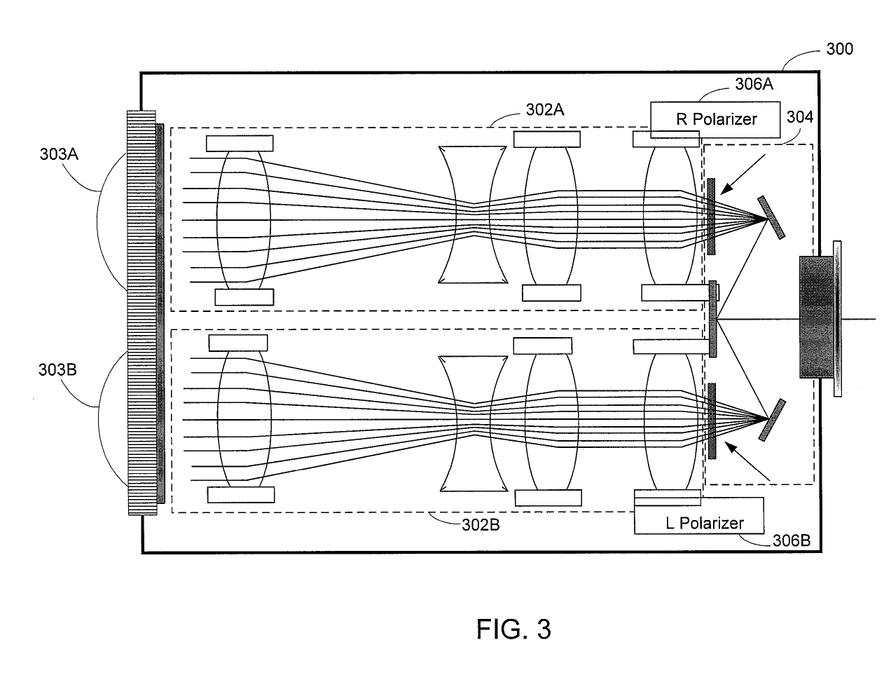

The lens module 102 captures a beam of light or images for a left eye and a right eye respectively. The beam of light is captured from two different viewpoints that are horizontally displaced from each other. In some embodiments, the horizontal displacement between the two viewpoints is approximately 65 mm, an average distance between a person's eyes. In one embodiment, the lens module 102 may include one or more polarization modules. The operation of the lens module and polarization module is discussed further with respect to FIG. 3.

The output module 104 includes one or more imagers 106, a processing module 108, and an encoding module 110. The output module 104 is operatively coupled with the lens module 102 for processing and encoding the combined beam of polarized light to produce the three-dimensional or stereoscopic images. Those skilled in the art will appreciate that various other output devices similar to the output module 104 may be configured to produce the image that may be broadcasted for multiple purposes.

The one or more imagers 106 receive the combined beam of light from the lens module 102. The processing module 108 processes the combined beam of polarized light and/or polarized image. In an embodiment, the processing module 108 may include one or more Digital Signal Processing (DSP) controllers for processing the combined beam of polarized light and/or polarized image.

In one embodiment, the lens module 102 and the output module 104 are operatively coupled via a controller 112. In an embodiment, the controller 112 facilitates the processing module 108 to have identical and matched left and right performance. In another embodiment, the controller 112 controls various image processing operations performed by the processing module 108. In an embodiment, the controller 112 is any type of microcomputer that comprises a Central Processing Unit (CPU), various support circuits, and a memory. The controller 112 reads out application programs stored in a ROM and executes the program using the CPU. The CPU may comprise one or more commercially available microprocessors or microcontrollers that facilitate data processing and storage. Various support circuits facilitate operation of the CPU and may include clock circuits, buses, power supplies, input/output circuits and/or the like. The memory includes a Read Only Memory, Random Access Memory, disk drive storage, optical storage, removable storage, and the like.

The encoding module 110 encodes the processed combined beam of polarized light and/or polarized images received from the processing module 108. In an embodiment, the encoding module 110 may include one or more High-Definition Serial Digital Interface (HDSDI) encoders. The encoding module 110 generates a three-dimensional HD image that may be further broadcasted for decoding by media or transmission devices.

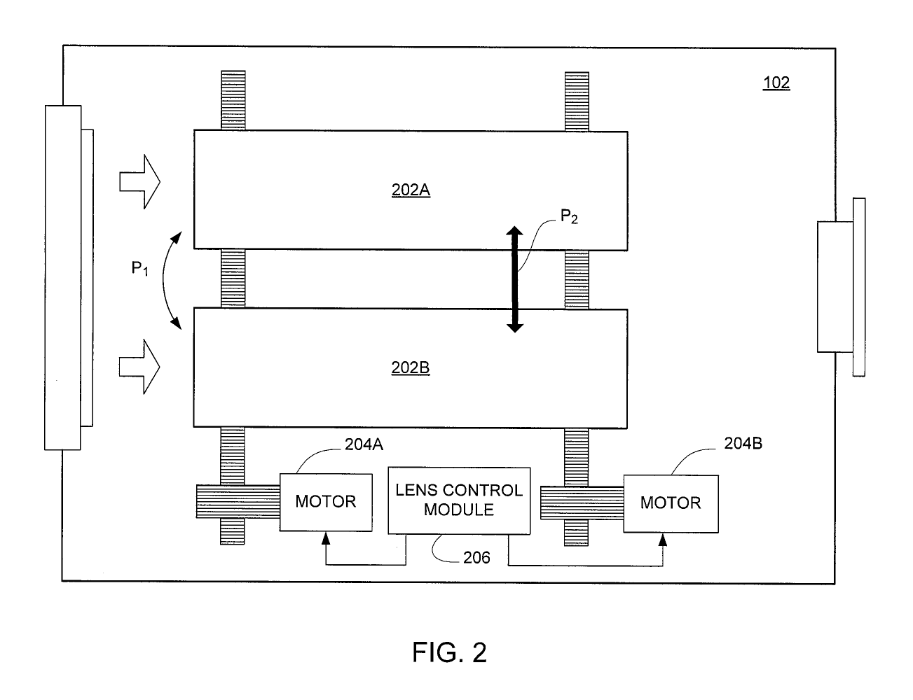

FIG. 2 is a block diagram of a lens module 102 according to one or more embodiments. The lens module 102 includes a left lens 202A, a right lens 202B, a lens control module 206 and one or more motors 204 (illustrated as a motor 204A and a motor 204B).

The left lens 202A and the right lens 202B captures a first polarized beam of light representing a first image and a second polarized beam of light representing a second image. In one embodiment, the first polarized beam of light and the second polarized beam of light are orthogonally polarized. In one embodiment, the lens module 102 converts the first and second polarized beam of light into a combined polarized beam of light using a filter module. The left lens 202A and the right lens 202B may be any kind of lens designed for three-dimensional imaging. Alternatively, the left lens 202A and the right lens 202B may be an alternating in time type of a lens. The left lens 202A and the right lens 202B are operatively controlled by the lens control module 206.

In an embodiment, the lens control module 206 is any type of microcomputer that comprises a Central Processing Unit (CPU), various support circuits and a memory. The CPU may comprise one or more commercially available microprocessors or microcontrollers that facilitate data processing and storage. Various support circuits facilitate operation of the CPU and may include clock circuits, buses, power supplies, input/output circuits and/or the like. The memory includes a Read Only Memory, Random Access Memory, disk drive storage, optical storage, removable storage, and the like for storing a control program or for storing data relating to status information.

In one embodiment, the lens control module 206 controls and optimizes various stereoscopic effects by adjusting the intraocular separation and convergence of the left lens 202A and the right lens 202B. The lens control module 206 operates with the motor 204A and the motor 204B to adjust the intraocular separation and the convergence of the left lens 202A and the right lens 202B. In some embodiments, the stereoscopic effects may include adjustment for stereovision near and adjustment for stereovision far by optimizing the intraocular separation and convergence between the left lens 202A and the right lens 202B of the lens module 102. For example, the lens control module 206 may instruct the motor 204A and the motor 204B to adjust the intraocular separation and/or divergence of the left lens 202A and the right lens 202B such that the lens module 102 may focus on object that is far away. Accordingly, the motor 204A operates to increase the distance between the left lens 202A and the right lens 202B at point P₁. Similarly, the lens control module 206 may instruct the motor 204A and the motor 204B to adjust the intraocular separation and/or convergence of the left lens 202A and the right lens 202B to focus on an object that is near to the lens module 102. As such, the motor 204B operates to increase the distance between the left lens 202A and the right lens 202B at point P₂.

The lens control module 206 controls both the motor 204A and the motor 204B simultaneously. For example, if the lens control module 206 adjusts the intraocular separation and convergence of the left lens 202A and the right lens 202B by operating the motor 204A by one ring or fifty Millimeters and/or the like, then the motor 204B also operates by one ring or fifty Millimeters and/or the like accordingly. In some embodiments, the motor 204A and the motor 204B may be controlled and/or operated mechanically, hydraulically, electronically and/or the like. Those skilled in the art will appreciate that the motor 204A and the motor 204B may be controlled and operated by various other means. In one embodiment, the left lens 202A and the right lens 202B may be controlled by the motor 204A and the motor 204B collectively. One of ordinary skill would recognize that other configurations, such as configuring individual motor for each of the left lens 202A and the right lens 202B, would result in equally valid embodiments of the present invention.

The lens control module 206 has prior information of the focal position (i.e., focus distance), a zoom position and/or the like. As such, the lens control module 206 may adjust and/or set an angle accordingly, to capture the image, by adjusting the intraocular separation and the convergence of the left lens 202A and the right lens 202B.

FIG. 3 is a detailed block diagram of the lenses 302 and polarization module 304 of the lens module 102. Light enters the lens module 102 through one or more apertures 303. In one embodiment, two apertures 303A and 303B are present, one for each beam of light. One of ordinary skill in the art would recognize that a single aperture or multiple apertures could be used, depending upon the required complexity of operation and the number of beams of light to be captured.

As light enters through the apertures 303, it travels through a lens array 302. In the present embodiment, two lens arrays 302A and 302B are described, but one or ordinary skill in the art would recognize that more lens arrays would be appropriate if additional beams of light were to be captured. As the lens arrays 302 direct and focus the beams of light, the beams are directed into a polarization module 304. The polarization module 304 uses polarization techniques generally known in the art to polarize the light entering through the apertures 303 and passing through the polarizing filters 306A and 306B.

The polarizing filters 306A and 306B may convert the light received from the lens module 102 into a vertically polarized beam of light and a horizontally polarized beam of light. For the purpose of simplicity, the left beam is referred to as a vertical polarized beam and the right beam is referred to as a horizontally polarized beam, but one of ordinary skill in the art would recognize that any two polarizing filters offset by 90 degrees would suffice. Linear polarization techniques for converting the light into horizontal and vertical polarization are discussed by way of example and are not intended to limit the invention to such. Although vertically polarized light is generally discussed with reference to a left image and horizontally polarized light with a right image, either polarization would suffice for either image. One of ordinary skill would recognize that other polarization techniques, such as circular polarization using prisms (resulting in left and right polarized light), would result in equally valid embodiments of the present invention. Those skilled in the art will appreciate that various other polarization devices similar to the filter modules may be configured for utilizing various polarization techniques.

The polarization module 304 mixes and/or combines the vertically polarized light and the horizontally polarized light received from the polarizing filters 306A and 306B to produce a combined beam of light. Although the two beams are combined into a single beam of light, no compression or loss of resolution occurs due to the combined beam being the result of two orthogonally polarized beams of light. In some embodiments, the polarization module 304 may include one or more mirrors for mixing and/or combining the vertically polarized beam and the horizontally polarized beam to produce a single beam of light. In other embodiments, various lenses, prisms, and the like may be used to combine the beams into a single beam. The polarized light is combined into a single beam of light and passed out of the lens module 102.

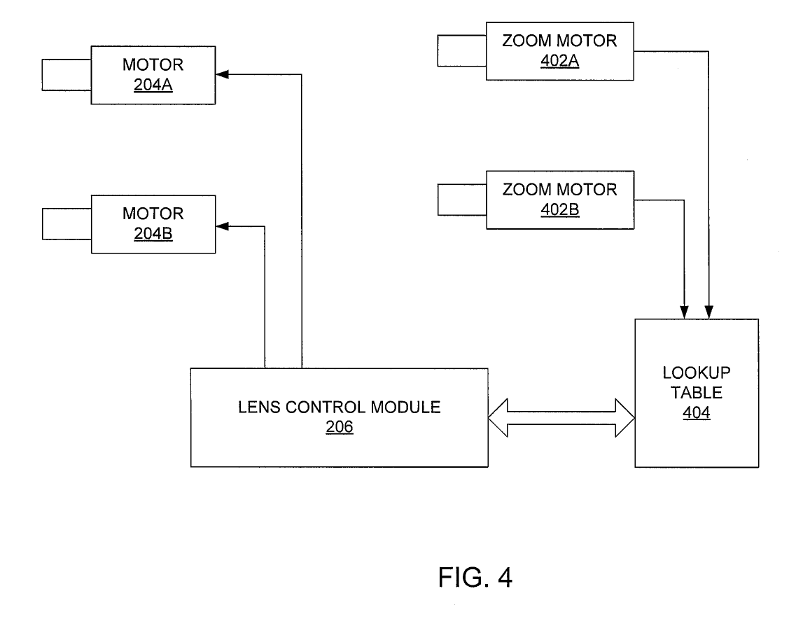

FIG. 4 is a detailed block diagram of the lens module 102 according to one or more embodiments of the present invention. The lens module 106 includes a lens control module 206, a lookup table 404, one or more motors 204 (illustrated as the motor 204A and the motor 204B) and a plurality of zoom motors 402 (illustrated as a zoom motor 402A and a zoom motor 402B).

As described above, the lens control module 206 adjusts the intraocular separation and convergence of a left lens (i.e. the left lens 202A of FIG. 2) and a right lens (i.e. the right lens 202B of FIG. 2) to optimize stereoscopic effects. In one embodiment, the lens control module 206 accesses the lookup table 404. In some embodiments, the lookup table 404 includes parameter data associated with one or more of the focal length (i.e. the focus distance), the iris length, the zoom position and/or the like. Accordingly, the lookup table 404 may be organized on the basis on the parameter data. For example, based on the type of lens utilized to capture the image, the lookup table 404 may be a focal distance lookup table and/or like. One of ordinary skill would recognize that other organizations of the lookup table 404, such as a zoom lookup table, an iris lookup table and/or the like, would result in equally valid embodiments of the present invention.

The lens control module 206 may receive a buffered feedback signal associated with the zoom position from a controller (i.e., the controller 112 of FIG. 1). Such a zoom position feedback signal is provided to the zoom motor 402A and the zoom motor 402B. On receiving the buffered feedback signal associated with the zoom position, the lens control module 206 may operate with the motor 204A and the motor 204B to adjust the back focus, the iris length, the zoom position, the lens module 102 angle and/or the like adjustments to optimize the stereoscopic effect. Thus, the left lens 202A and the right lens 202B are locked to have the identical iris, a zoom position and the back focus settings.

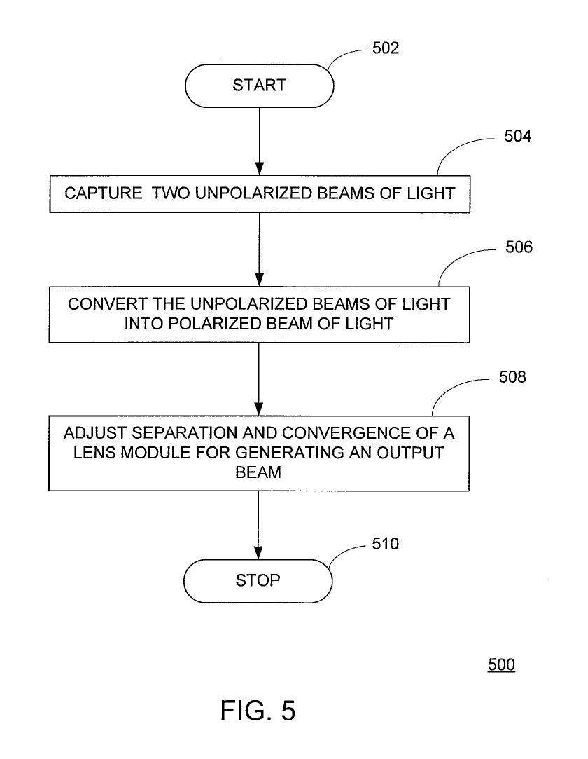

FIG. 5 is a flow diagram of a method 500 for optimizing stereoscopic effect according to one or more embodiments of the present invention. The method 500 starts at step 502 and proceeds to step 504. At step 504, an unpolarized beam of light is captured. In one embodiment, the unpolarized beam of light is captured by a left lens (i.e., the left lens 202A of FIG. 2) and a right lens (i.e., the right lens 202B of FIG. 2). At step 506, the unpolarized beam of light is converted into polarized beam of light. At step 508, the intraocular separation and convergence of the lens module (i.e., the left lens 202A and the right lens 202B of FIG. 2) is adjusted for generating an output stream. In one embodiment, a lens control module (i.e., the lens control module 206 of FIG. 2) adjusts the intraocular separation and convergence of the lenses (i.e., the left lens 202A and the right lens 202B of FIG. 2) and such adjustment of the lenses is facilitated by one or more motors (i.e., the motor 204A and the motor 204B of FIG. 2 and the zoom motor 302A and the zoom motor 302B of FIG. 3). The method 500 proceeds to step 510, at which the method 500 ends.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated. While the foregoing is directed to embodiments of the present invention, other and further embodiments of the invention may be devised without departing from the basic scope thereof, and the scope thereof is determined by the claims that follow.

1. A method for optimizing stereoscopic effect comprising:
capturing a first unpolarized beam of light representing a first image and a second unpolarized beam of light representing a second image using a lens module;
converting the first and second unpolarized beam of light into the first polarized beam of light and the second polarized beam of light using a filter module; and
adjusting separation and convergence of the lens module using a lens control module for generating an output stream.

2. The method of claim 1 further comprising processing the output stream using a processing module.

3. The method of claim 1 further comprising encoding the processed output stream received from the processing module using an encoding module.

4. The method of claim 1, wherein the adjusting step comprises:
synchronizing at least one or more parameter data.

5. The method of claim 4, wherein synchronizing the at least one or more parameter data further comprises synchronizing at least one or more of an iris parameter, a zoom parameter, and a focal length setting parameter.

6. The method of claim 4 further comprising accessing a lookup table, wherein the lookup table comprises at least one of the iris parameter, the zoom parameter and the focal length setting parameters of the lens module.

7. The method of claim 1, wherein adjusting separation and convergence of the lens module utilizes one or more motors operatively coupled with the lens control module.

8. The method of claim 1, wherein the first polarized beam and the second polarized beam are orthogonally polarized.

9. The method of claim 1, wherein the capturing step comprises:
capturing a first unpolarized beam of light representing a first image and a second unpolarized beam of light representing a second image using a lens module;
converting the light into the first polarized beam of light and the second polarized beam of light using a filter module; and
combining the first polarized image and the second polarized image into the combined beam of light using a polarization array.

10. An apparatus for optimizing stereoscopic effect comprising:
a lens module for capturing a first unpolarized beam of light representing a first image and a second unpolarized beam of light representing a second image;
a filter module for converting the first and second unpolarized beam of light into the first polarized beam of light and the second polarized beam of light; and
a lens control module for adjusting separation and convergence of the lens module for generating an output stream.

11. The apparatus of claim 10, wherein the lens control module synchronizes at least one or more parameter data.

12. The apparatus of claim 10, wherein the at least one or more parameter data comprises at least one or more of iris parameter, zoom parameter, focal length setting parameter.

13. The apparatus of claim 11, wherein the a lens control module accesses a lookup table, wherein the lookup table comprises at least one of the iris parameter, the zoom parameter and the focal length setting parameters of the lens module.

14. The apparatus of claim 10 further comprising one or more motors operatively coupled with the lens control module for adjusting separation and convergence of the lens module.
